(19) United States
(12) Patent Application Publication
(10) Pub. No.: US 2026/0329133 A1
(43) Pub. Date: Oct. 22, 2026

(54) BACKLIGHT DEVICE AND DISPLAY DEVICE

(71) Applicant: Sharp Display Technology Corporation, Kameyama City (JP)

(72) Inventors: Mayumi HORI, Kameyama City (JP); Kenichi Iwamoto, Kameyama City (JP); Hiroki Fukai, Kameyama City (JP)

(21) Appl. No.: 19/649,520

(22) Filed: Apr. 16, 2026

(30) Foreign Application Priority Data
Apr. 22, 2025 (JP) 2025-070466

(51) Int. Cl. G02F 1/13357

(52) U.S. Cl. CPC G02F 1/133608

(57) ABSTRACT

A backlight device includes a substrate having a main surface, an optical sheet facing the main surface of the substrate, a plurality of light-emitting elements supported on the main surface of the substrate and emitting light toward the optical sheet, a dividing member, and a plurality of support members. The dividing member forms, between the main surface of the substrate and the optical sheet, a plurality of spaces each accommodating one or more of the plurality of light-emitting elements. The dividing member includes a plurality of wall portions each surrounding, in a top view, the light-emitting elements accommodated in each of the plurality of spaces, and a plurality of top portions each connecting the wall portions adjacent to each other in the plurality of wall portions. The plurality of support members each are in contact with the top portions of the dividing member and support the optical sheet.

### CROSS-REFERENCE TO RELATED APPLICATIONS

This application claims the benefit of priority to Japanese Patent Application Number 2025-070466 filed on Apr. 22, 2025. The entire contents of the above-identified application are hereby incorporated by reference.

### BACKGROUND

### TECHNICAL FIELD

The disclosure relates to a backlight device and a display device.

Many liquid crystal display devices include a backlight device including a plurality of light sources (for example, a plurality of LEDs). A backlight device is classified into an edge type and a direct type according to a positional relationship between a light extraction surface and a light source. The plurality of LEDs included in a direct type backlight device are, for example, divided into a plurality of regions, and only the LEDs in the regions requiring illumination light are turned on, or luminance may be adjusted for each region as required. Such a driving method is referred to as partial driving, divided driving, area driving, or local dimming. By driving the backlight device by a partial driving method, a luminance contrast ratio between a bright portion and a dark portion of a display device including such a backlight device can be improved.

In the backlight device being driven by the partial driving method, light from a lighting region in which the LEDs are turned on may enter a non-lighting region in which the LEDs are turned off. For improving the contrast ratio between the lighting region and the non-lighting region adjacent to the lighting region, a member that divides the LEDs for each unit region may be provided. For example, JP 2018-22683 A describes a surface light-emitting device including a dividing member provided so as to surround each of the light sources. WO 2017/191714 describes a backlight device including a reflective partition wall provided so as to surround an LED unit formed from one or more blue LEDs.

### SUMMARY

In a backlight device including a plurality of light sources, when a dividing member that divides the plurality of light sources into unit regions is provided, luminance unevenness may occur due to a local decrease in luminance in the vicinity of the dividing member. Details will be described below.

The disclosure is made to solve the above-described problems, and has an object of providing a backlight device that is able to suppress luminance unevenness caused by a dividing member, and a display device including such a backlight device.

According to embodiments of the disclosure, solutions described in the following items are provided.

### Item 1

A backlight device includes a substrate having a main surface, an optical sheet facing the main surface of the substrate, a plurality of light-emitting elements supported on the main surface of the substrate and configured to emit light toward the optical sheet, a dividing member forming, between the main surface of the substrate and the optical sheet, a plurality of spaces each accommodating one or more of the plurality of light-emitting elements, the dividing member including a plurality of wall portions each surrounding, in a top view, the light-emitting elements accommodated in each of the plurality of spaces, and a plurality of top portions each connecting the wall portions adjacent to each other in the plurality of wall portions, and a plurality of support members each in contact with the top portions of the dividing member and configured to support the optical sheet.

### Item 2

The backlight device according to item 1, in which a gap is formed between the optical sheet and portions of the top portions of the dividing member not in contact with the support members.

### Item 3

The backlight device according to item 1 or 2, in which the plurality of support members are separated from each other in a top view.

### Item 4

The backlight device according to any one of items 1 to 3, in which the plurality of top portions include a plurality of first top portions extending in a first direction in a top view, and a plurality of second top portions extending in a second direction intersecting the first direction in a top view.

### Item 5

The backlight device according to item 4, in which each of the plurality of support members is provided at some or all intersections between the plurality of first top portions and the plurality of second top portions.

### Item 6

The backlight device according to item 4 or 5, in which the plurality of top portions are formed in a lattice pattern including the plurality of first top portions and the plurality of second top portions in a top view.

### Item 7

The backlight device according to any one of items 4 to 6, in which each of the plurality of support members is not provided anywhere other than at intersections between the plurality of first top portions and the plurality of second top portions.

### Item 8

The backlight device according to any one of items 1 to 3, in which the plurality of top portions include either a plurality of first top portions extending in a first direction in a top view, or a plurality of second top portions extending in a second direction intersecting the first direction in a top view.

### Item 9

The backlight device according to item 8, in which the plurality of top portions include the plurality of first top portions, when assuming a virtual partition including a plurality of portions extending in the second direction, the plurality of first top portions and the plurality of portions being formed in a lattice pattern in a top view, and dividing each of the plurality of light-emitting elements, the plurality of support members are arranged, in a top view, at intersections between the plurality of first top portions and the plurality of portions.

### Item 10

The backlight device according to item 8, in which the plurality of top portions include the plurality of second top portions, when assuming a virtual partition including a plurality of portions extending in the first direction, the plurality of second top portions and the plurality of portions being formed in a lattice pattern in a top view, and dividing each of the plurality of light-emitting elements, the plurality of support members are arranged, in a top view, at intersections between the plurality of second top portions and the plurality of portions.

### Item 11

The backlight device according to any one of items 1 to 10, in which the plurality of support members have light reflectivity.

### Item 12

The backlight device according to any one of items 1 to 10, in which the plurality of support members include a fluorescent substance emitting fluorescence upon receiving the light.

### Item 13

A display device includes a display panel, and a backlight device according to any one of items 1 to 12, the backlight device emitting light toward a back face of the display panel.

According to embodiments of the disclosure, a backlight device that is able to suppress luminance unevenness caused by a dividing member, and a display device including such a backlight device are provided.

### BRIEF DESCRIPTION OF DRAWINGS

The disclosure will be described with reference to the accompanying drawings, wherein like numbers reference like elements.

FIG. 1A is a schematic side view illustrating a backlight device 50A according to a first embodiment of the disclosure.

FIG. 1B is a schematic plan view illustrating the backlight device 50A.

FIG. 1C is a schematic cross-sectional view illustrating the backlight device 50A, and is a cross-sectional view taken along line 1C-1C' in FIG. 1B.

FIG. 1D is a schematic side view illustrating a display device 100A including the backlight device 50A.

FIG. 2A is a diagram schematically illustrating a state in which only a part of a plurality of light-emitting elements 22 included in the backlight device 50A is turned on.

FIG. 2B is a diagram schematically illustrating a state in which all of the plurality of light-emitting elements 22 included in the backlight device 50A are turned on.

FIG. 3 is a schematic side view illustrating a backlight device 50A1 according to a first modification example of the first embodiment.

FIG. 4 is a schematic side view illustrating a backlight device 50A2 according to a second modification example of the first embodiment.

FIG. 5 is a schematic side view illustrating a backlight device 50A3 according to a third modification example of the first embodiment.

FIG. 6A is a schematic side view illustrating a backlight device 50B according to a second embodiment of the disclosure.

FIG. 6B is a schematic plan view illustrating the backlight device 50B.

FIG. 7A is a schematic side view illustrating a backlight device 50C according to a third embodiment of the disclosure.

FIG. 7B is a schematic plan view illustrating the backlight device 50C.

FIG. 8A is a schematic side view illustrating a backlight device 50D according to a fourth embodiment of the disclosure.

FIG. 8B is a schematic plan view illustrating the backlight device 50D.

FIG. 8C is a schematic diagram for explaining an arrangement of a support member 32 in the backlight device 50D.

FIG. 8D is a schematic plan view illustrating a backlight device 50D1 according to a modified example of the fourth embodiment.

FIG. 8E is a schematic diagram for explaining an arrangement of the support member 32 in the backlight device 50D1.

FIG. 9 is a schematic cross-sectional view illustrating a backlight device 90A according to a first comparative example.

FIG. 10 is a schematic cross-sectional view illustrating a backlight device 90B according to a second comparative example.

FIG. 11A is a diagram schematically illustrating luminance when only a part of a plurality of light-emitting elements 22 included in the backlight device 90A according to the first comparative example is turned on.

FIG. 11B is a diagram schematically illustrating luminance when all of the plurality of light-emitting elements 22 included in the backlight device 90A according to the first comparative example are turned on.

FIG. 12A is a diagram schematically illustrating luminance when only a part of a plurality of light-emitting elements 22 included in a backlight device 90B according to the second comparative example is turned on.

FIG. 12B is a diagram schematically illustrating luminance when all of the plurality of light-emitting elements 22 included in the backlight device 90B according to the second comparative example are turned on.

### DESCRIPTION OF EMBODIMENTS

Embodiments of the disclosure will be described below with reference to the drawings. Note that the disclosure is not limited to the embodiments described below. In the following drawings, constituent elements having substantially the same functions may be denoted by common reference signs, and description thereof may be omitted. In the drawings, for reference, arrows illustrating an x direction, a y direction, and a z direction orthogonal to each other may be illustrated.

### First Embodiment

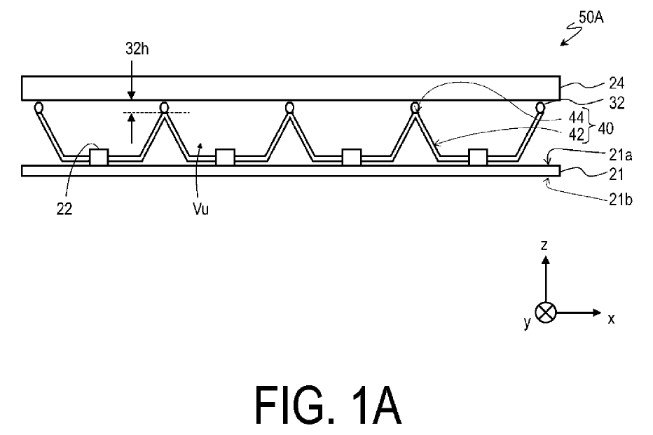

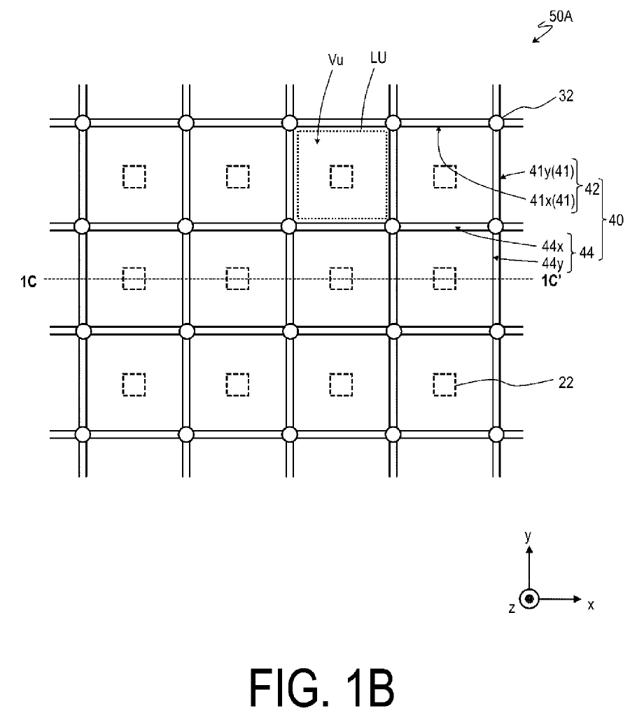

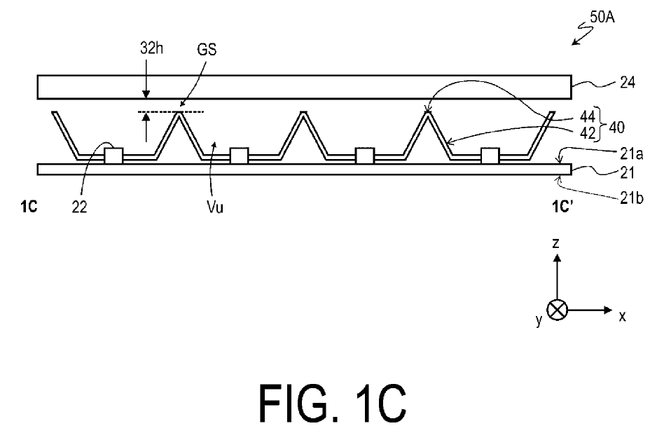

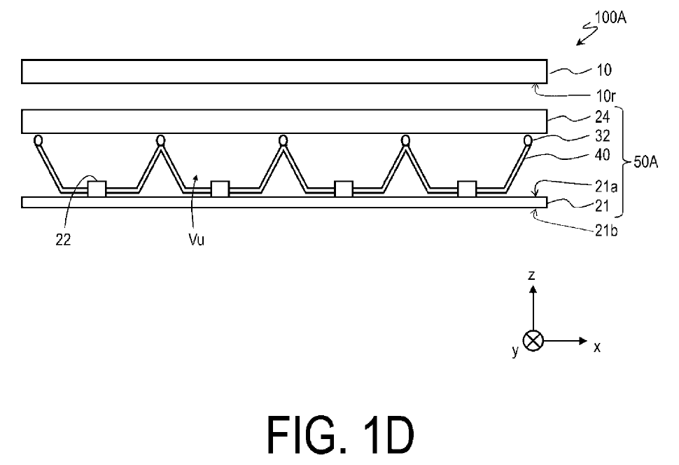

With reference to FIGS. 1A, 1B, 1C and 1D, a backlight device 50A according to the present embodiment and a display device 100A including the backlight device 50A will be described. FIG. 1A is a schematic side view illustrating the backlight device 50A. FIG. 1B is a schematic plan view illustrating the backlight device 50A. FIG. 1C is a schematic cross-sectional view illustrating the backlight device 50A, and is a cross-sectional view taken along line 1C-1C' in FIG. 1B. FIG. 1D is a schematic side view illustrating the display device 100A including the backlight device 50A.

As illustrated in FIG. 1D, the display device (for example, a liquid crystal display device) 100A includes a display panel (for example, a liquid crystal display panel) 10 and the backlight device 50A. In the display device 100A, the backlight device 50A emits light toward a back face 10r of the display panel 10.

With reference to FIGS. 1A-1C, the backlight device 50A is described. The backlight device 50A includes a substrate 21, a plurality of light-emitting elements 22, an optical sheet 24, a dividing member 40, and a plurality of support members 32.

The substrate 21 includes a main surface 21a and another main surface 21b on an opposite side of the main surface 21a.

The optical sheet 24 is arranged to face the main surface 21a of the substrate 21. The optical sheet 24 is, for example, a diffuser plate.

The plurality of light-emitting elements 22 are supported on the main surface 21a of the substrate 21. The plurality of light-emitting elements 22 emit light toward the optical sheet 24. That is, the plurality of light-emitting elements 22 are arranged between the main surface 21a of the substrate 21 and the optical sheet 24. The plurality of light-emitting elements 22 are arrayed two-dimensionally on the main surface 21a of the substrate 21. As illustrated in FIG. 1B, the plurality of light-emitting elements 22 are arrayed in a matrix shape including a plurality of rows and a plurality of columns in a top view (that is, when viewed from a normal direction of the main surface 21a of the substrate 21). In the drawing, a row direction is indicated as the x direction, and a column direction is indicated as the y direction. The plurality of light-emitting elements 22 are, for example, white LEDs that emit white light. Of the light emitted from the plurality of light-emitting elements 22, light transmitted through the optical sheet 24 (for example, a diffuser plate) may be emitted from the backlight device 50A. For example, in the display device 100A, of light emitted from the plurality of light-emitting elements 22, light transmitted through the optical sheet 24 is emitted toward the back face 10r of the display panel 10.

The dividing member 40 forms, between the main surface 21a of the substrate 21 and the optical sheet 24, a plurality of spaces Vu, each of which accommodates one or more of the plurality of light-emitting elements 22. In this example, one light-emitting element 22 is accommodated in each of the plurality of spaces Vu, but two or more light-emitting elements 22 may be accommodated in each space Vu. The backlight device 50A can perform partial driving by using, as a unit, one or more of the plurality of light-emitting elements 22 accommodated in each space Vu. On a light-emitting face of the backlight device 50A, a region serving as a unit in which partial driving is performed may be referred to as "a unit region LU". That is, the backlight device 50A can also be described as performing partial driving by using, as a unit, one or more of the light-emitting elements 22 included in the unit region LU. In this example, each unit region LU corresponds to any one of the plurality of spaces Vu (for example, coincides with any one of the plurality of spaces Vu).

The dividing member 40 includes a plurality of wall portions 42 each surrounding, in a top view (that is, when viewed from the normal direction of the main surface 21a of the substrate 21), the light-emitting element 22 accommodated in each of the plurality of spaces Vu, and a plurality of top portions 44 each connecting the wall portions 42 adjacent to each other among the plurality of wall portions 42. Each of the plurality of wall portions 42 is provided corresponding to each of the plurality of spaces Vu. In this example, each of the plurality of wall portions 42 can also be described as being provided corresponding to each unit region LU. For example, the unit regions LU are arrayed two-dimensionally in a top view, and accordingly, the wall portions 42 are also arrayed two-dimensionally in a top view. Each of the plurality of top portions 44 is provided between the two wall portions 42 adjacent to each other among the plurality of wall portions 42. When the unit regions LU and the wall portions 42 are arrayed two-dimensionally in a top view, the plurality of top portions 44 may be formed in a lattice pattern in a top view.

Each of the plurality of wall portions 42 includes, in a top view, a plurality of side surfaces 41 (here, four side surfaces 41) surrounding, in a rectangular shape, the light-emitting element 22 accommodated in each of the plurality of spaces Vu. In a top view, the space Vu having a rectangular shape defined by each wall portion 42 includes a first side extending in a first direction (x direction in the drawing) and a second side extending in a second direction (y direction in the drawing) intersecting the first direction (for example, orthogonal to the first direction). The plurality of side surfaces 41 included in each wall portion 42 include a first side surface 41x constituting the first side and a second side surface 41y constituting the second side. The first side surface 41x and the second side surface 41y may be collectively referred to as a side surface 41. The first direction and the second direction are, for example, the row direction and the column direction, respectively.

The plurality of top portions 44 include, in a top view, a plurality of first top portions 44x extending in the first direction, and, in a top view, a plurality of second top portions 44y extending in the second direction. In the illustrated example, the plurality of top portions 44 are formed in a lattice pattern including the plurality of first top portions 44x and the plurality of second top portions 44y in a top view. The surface including the plurality of top portions 44 may be continuously and integrally formed.

Each of the plurality of support members 32 is in contact with the top portion 44 of the dividing member 40 and supports the optical sheet 24. For example, each of the plurality of support members 32 is in contact with the top portion 44 of the dividing member 40 and the optical sheet 24. The plurality of support members 32 are arranged, in a top view, at the intersections of the plurality of first top portions 44x and the plurality of second top portions 44y. In this example, the plurality of support members 32 are arranged, in a top view, at all of the intersections of the plurality of first top portions 44x and the plurality of second top portions 44y. The plurality of support members 32 are separated from each other in a top view. In this example, each of the plurality of support members 32 is not provided anywhere other than at the intersections between the first top portions 44x and the second top portions 44y. As illustrated in FIG. 1C, a gap GS is formed between a portion of the top portion 44 of the dividing member 40 that is not in contact with the support member 32 and the optical sheet 24. By arranging the plurality of support members 32 at least in a part of the intersections between the plurality of first top portions 44x and the plurality of second top portions 44y, the optical sheet 24 can be stably supported, for example, compared with a case in which the plurality of support members 32 are arranged only in areas other than at the intersections. From a viewpoint of stably supporting the optical sheet 24, the plurality of support members 32 are preferably arranged at all of the intersections between the plurality of first top portions 44x and the plurality of second top portions 44y.

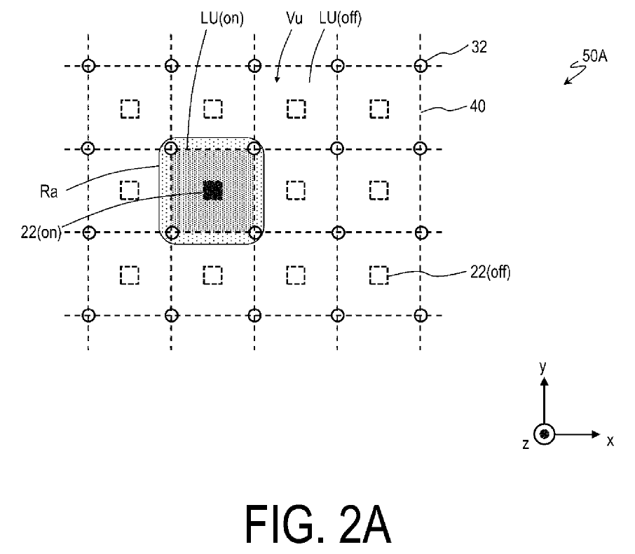

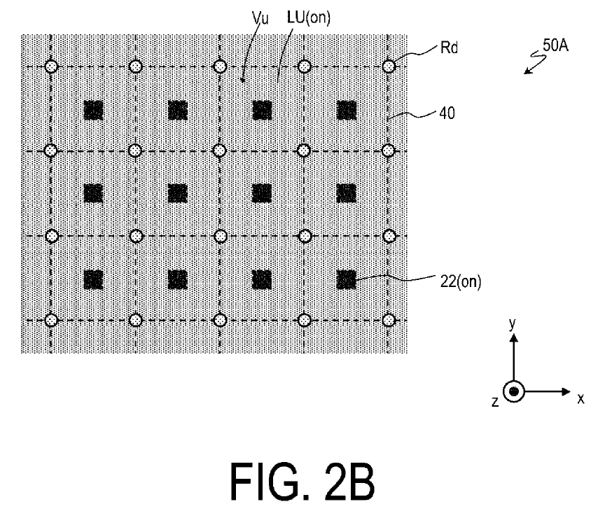

FIG. 2A is a diagram schematically illustrating a state in which only a part of the plurality of light-emitting elements 22 included in the backlight device 50A is turned on, and FIG. 2B is a diagram schematically illustrating a state in which all of the plurality of light-emitting elements 22 included in the backlight device 50A are turned on. In FIG. 2A, "(on)" is added to a reference sign of the light-emitting element 22 that is turned on (that is, emits light), and "(off)" is added to a reference sign of the light-emitting element 22 that is not turned on (that is, does not emit light), and a state in which the backlight device 50A performs partial driving is schematically illustrated. Similarly, "(on)" is added to a reference sign of the unit region LU that is turned on, and "(off)" is added to a reference sign of the unit region LU that is not turned on. When the backlight device 50A performs partial driving, the light-emitting face of the backlight device 50A includes a lighting region corresponding to the unit region LU (on) that is turned on and a non-lighting region corresponding to the unit region LU (off) that is not turned on. In FIGS. 2A and 2B, the dividing member 40 is illustrated by a broken line for simplicity.

As described below, the backlight device 50A can suppress luminance unevenness caused by the dividing member 40 with the plurality of support members 32 included.

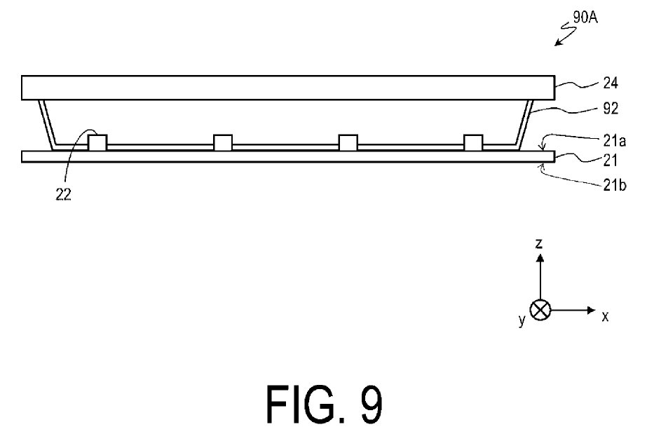

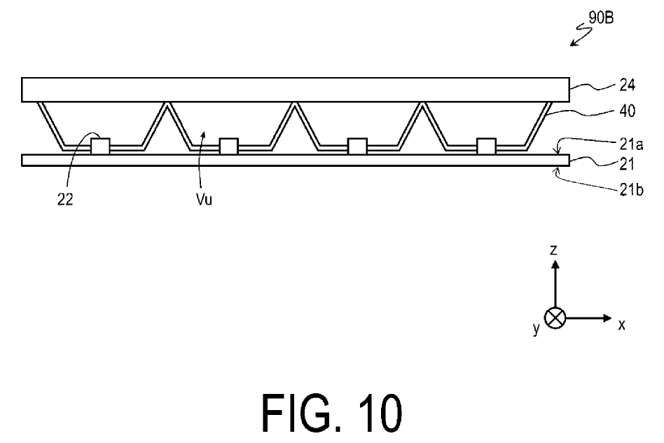

First, while comparing with the backlight devices of comparative examples illustrated in FIGS. 9 and 10, explanation is provided that the backlight device 50A can suppress luminance unevenness. FIG. 9 is a schematic cross-sectional view illustrating a backlight device 90A according to a first comparative example, and FIG. 10 is a schematic cross-sectional view illustrating a backlight device 90B according to a second comparative example. With respect to the backlight device 90A according to the first comparative example and the backlight device 90B according to the second comparative example, description of matters common to the backlight device 50A of the present embodiment may be omitted.

The backlight device 90B according to the second comparative example illustrated in FIG. 10 differs from the backlight device 50A of the present embodiment in that the backlight device 90B does not include the plurality of support members 32. The backlight device 90A according to the first comparative example illustrated in FIG. 9 differs from the backlight device 90B according to the second comparative example in that the backlight device 90A includes a cover member 92 instead of the dividing member 40. The cover member 92 surrounds the plurality of light-emitting elements 22 between the main surface 21a of the substrate 21 and the optical sheet 24. The backlight device 90A according to the first comparative example does not include the dividing member that divides the plurality of light-emitting elements 22 into unit regions.

First, by comparing the backlight device 90A according to the first comparative example with the backlight device 90B according to the second comparative example, an operation and an effect of the dividing member 40 are explained.

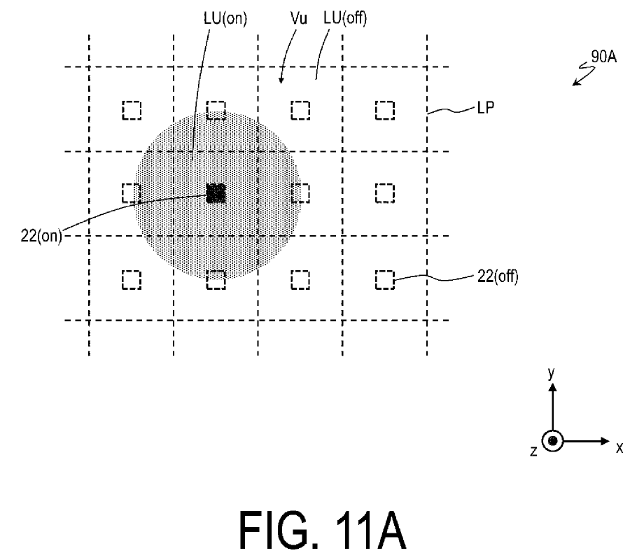

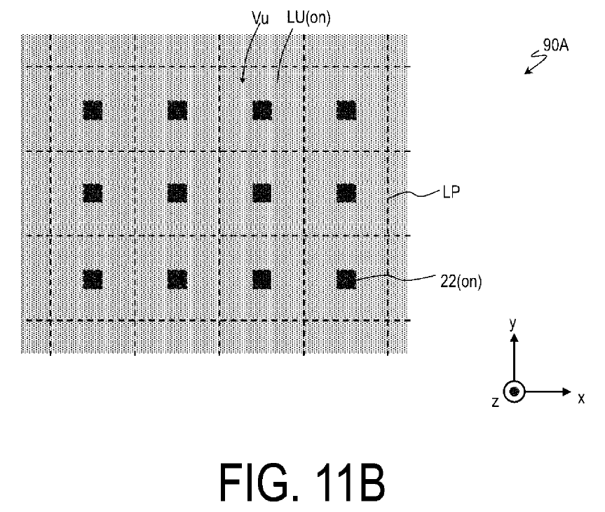

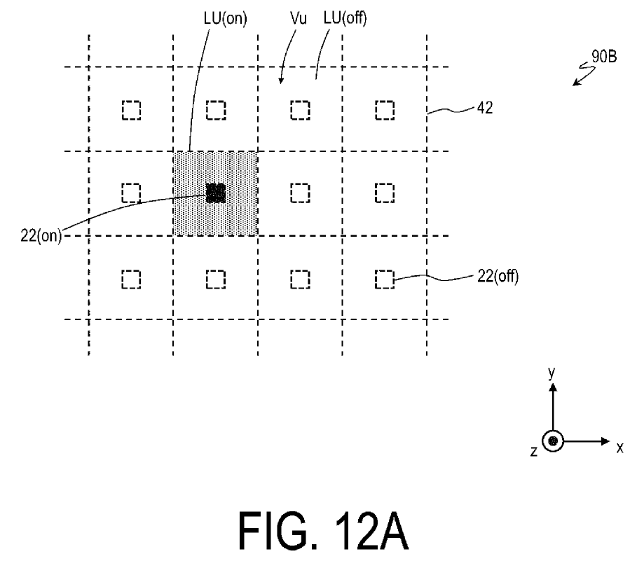

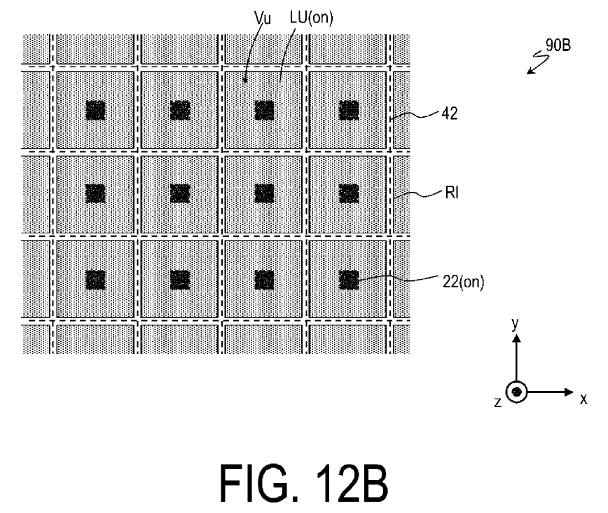

FIG. 11A is a diagram schematically illustrating luminance when only a part of the plurality of light-emitting elements 22 included in the backlight device 90A according to the first comparative example is turned on, and FIG. 11B is a diagram schematically illustrating luminance when all of the plurality of light-emitting elements 22 included in the backlight device 90A according to the first comparative example are turned on. FIG. 12A is a diagram schematically illustrating luminance when only a part of the plurality of light-emitting elements 22 included in the backlight device 90B according to the second comparative example is turned on, and FIG. 12B is a diagram schematically illustrating luminance when all of the plurality of light-emitting elements 22 included in the backlight device 90B according to the second comparative example are turned on. In FIGS. 11A and 11B, the backlight device 90A according to the first comparative example does not include the dividing member that divides the plurality of light-emitting elements 22 into the unit regions, but a virtual lattice-pattern partition LP that divides each of the plurality of light-emitting elements 22 is illustrated for ease of understanding. Each region divided by the lattice-pattern partition LP corresponds to the unit region LU.

As illustrated in FIG. 11A, since the backlight device 90A according to the first comparative example does not include the dividing member that divides the plurality of light-emitting elements 22 into the unit regions, when partial driving is performed, light emitted from the light-emitting element 22 (on) that is turned on may enter the adjacent unit region LU (off) that is not turned on. As a result, a luminance contrast ratio between the unit region LU (on) that is turned on and the unit region LU (off) that is not turned on decreases. In the display device including such a backlight device 90A, display quality may decrease. Note that, in the backlight device 90A according to the first comparative example that does not include the dividing member, as illustrated in FIG. 11B, luminance unevenness caused by the dividing member does not occur.

In contrast, since the backlight device 90B according to the second comparative example includes the dividing member 40, as illustrated in FIG. 12A, the luminance contrast ratio between the unit region LU (on) that is turned on and the unit region LU (off) that is not turned on is improved compared with the backlight device 90A according to the first comparative example. Since the backlight device 90B according to the second comparative example includes the dividing member 40, when partial driving is performed, light emitted from the light-emitting element 22 (on) that is turned on can be suppressed from being incident on the adjacent unit region LU (off) that is not turned on.

However, in the backlight device 90B according to the second comparative example, luminance unevenness caused by the dividing member 40 may occur. As illustrated in FIG. 12B, when adjacent unit regions LU are both turned on, luminance unevenness occurs due to a local decrease in luminance between the adjacent unit regions LU. Specifically, in a top view, a region Rl along the dividing member 40 locally becomes dark. For example, when the dividing member 40 is formed in a lattice pattern in a top view, lattice-pattern luminance unevenness is formed. The luminance unevenness having the shape of the dividing member 40 occurs due to the top portion of the dividing member 40 being in contact with the optical sheet 24. The luminance locally decreases along the shape of the dividing member 40 that is in contact with the optical sheet 24.

Note that, although FIG. 12B schematically illustrates a state in which all of the plurality of light-emitting elements 22 are turned on, luminance unevenness caused by the dividing member 40 as described above is not limited to a case in which all of the plurality of light-emitting elements 22 included in the backlight device 90B are turned on, and may occur when a plurality of adjacent unit regions LU are turned on.

In contrast, since the backlight device 50A according to the present embodiment includes the plurality of support members 32, as illustrated in FIG. 2B, luminance unevenness caused by the dividing member 40 is suppressed compared with the backlight device 90B according to the second comparative example. In the backlight device 50A, as described above, since the plurality of support members 32 are arranged separated from each other between the top portions 44 of the dividing member 40 and the optical sheet 24, an area where the optical sheet 24 and members that support the optical sheet 24 (that is, the plurality of support members 32) meet can be reduced. In the backlight device 50A, as illustrated in FIG. 2B, luminance may locally decrease in a region Rd corresponding to the support member 32. However, luminance unevenness caused by the plurality of support members 32 is separated from each other and, for example, is island-shaped in a top view, and therefore is less likely to be visually recognized than luminance unevenness having the shape of the dividing member 40 that occurs in the backlight device 90B according to the second comparative example.

As illustrated in FIG. 2A, in the backlight device 50A, the luminance contrast ratio between the unit region LU (on) that is turned on and the unit region LU (off) that is not turned on may be inferior compared with the backlight device 90B according to the second comparative example. In the backlight device 50A, since the gap GS (see FIG. 1C) is formed between the top portion 44 of the dividing member 40 and the optical sheet 24, light emitted from the light-emitting element 22 accommodated in each space Vu can be incident on the adjacent spaces Vu via the gap GS. As a result, light may leak into a region Ra around the unit region LU (on) that is turned on. However, since the backlight device 50A includes the dividing member 40, the luminance contrast ratio between the unit region LU (on) that is turned on and the unit region LU (off) that is not turned on is improved compared with the backlight device 90A according to the first comparative example that does not include the dividing member 40. Therefore, in the backlight device 50A, the luminance contrast ratio between the unit region LU (on) that is turned on and the unit region LU (off) that is not turned on is improved, while luminance unevenness caused by the dividing member 40 is suppressed.

The plurality of support members 32 are formed of, for example, a resin material. As the resin material forming the support members 32, for example, a thermosetting resin or an ultraviolet-curing resin can be used. The support members 32 can be produced by, for example, potting. Specifically, the support members 32 are obtained by dropping, using a liquid resin dispenser, a solution including a resin material onto intersections between a plurality of first portions 42x and a plurality of second portions 42y of the dividing member 40, and curing the dropped solution. By producing the support member 32 by potting, a thickness 32h of the support members 32 (a length in the z-axis direction in the drawing) can be adjusted as appropriate. The width of the gap GS is determined by the thickness 32h of the support members 32. As described with reference to FIG. 2A, in a case in which the width of the gap GS is excessively large, the luminance contrast ratio between the unit region LU (on) that is turned on and the unit region LU (off) that is not turned on may decrease, and therefore, the thickness 32h of the support members 32 (that is, the width of the gap GS) may be adjusted so that a decrease in the luminance contrast ratio is suppressed.

The backlight device 50A, for example, with respect to the backlight device 90B according to the second comparative example, further includes the plurality of support members 32, so that luminance unevenness caused by the dividing member 40 can be reduced, and therefore, reduction in luminance unevenness caused by the dividing member 40 can be achieved while suppressing an increase in manufacturing cost. For example, since changing a structure or a shape of the dividing member 40 or applying processing to the dividing member 40 is unnecessary, an increase in manufacturing cost can be suppressed.

### First Modification Example

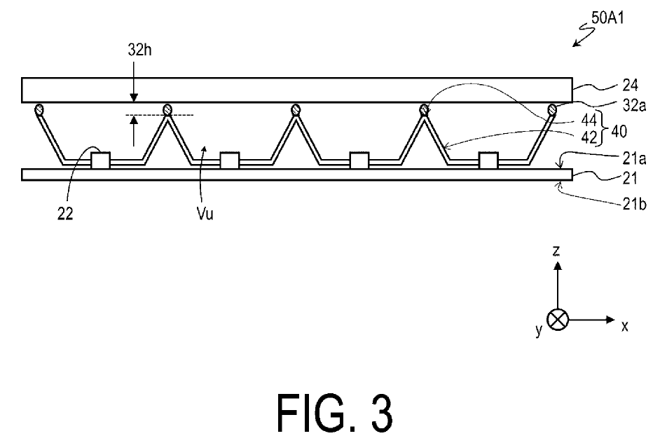

With reference to FIG. 3, a backlight device 50A1 according to a first modification example of the present embodiment will be described. FIG. 3 is a schematic side view illustrating the backlight device 50A1. In the following, differences from the backlight device 50A will be mainly described.

The backlight device 50A1 differs from the backlight device 50A in that a plurality of support members 32a have light reflectivity. The expression "the plurality of support members 32a having light reflectivity" means that the plurality of support members 32a have reflectivity of 70% or more, and preferably have reflectivity of 90% or more, with respect to light emitted from the light-emitting elements 22. The support member 32a having light reflectivity can be formed using a resin material having light reflectivity. For example, a resin material containing a reflective material such as light-reflective particles or a light-reflective resin (for example, a white resin) can be used as resin for forming the support members 32 described above (for example, a thermosetting resin or an ultraviolet-curing resin).

Also in the backlight device 50A1, similarly to the backlight device 50A, the luminance contrast ratio between the unit region LU (on) that is turned on and the unit region LU (off) that is not turned on is improved, while luminance unevenness caused by the dividing member 40 is suppressed. In the display device including the backlight device 50A1, similarly to the display device 100A including the backlight device 50A, the display quality is improved.

In the backlight device 50A1, since the support members 32a have light reflectivity with respect to light emitted from the light-emitting elements 22, a local decrease in luminance in a region corresponding to the support members 32a is reduced compared with the backlight device 50A. That is, in the backlight device 50A1, luminance unevenness caused by the support members 32a is reduced compared with luminance unevenness caused by the support members 32 in the backlight device 50A. In the display device including the backlight device 50A1, the display quality can be further improved compared with the display device 100A including the backlight device 50A.

### Second Modification Example

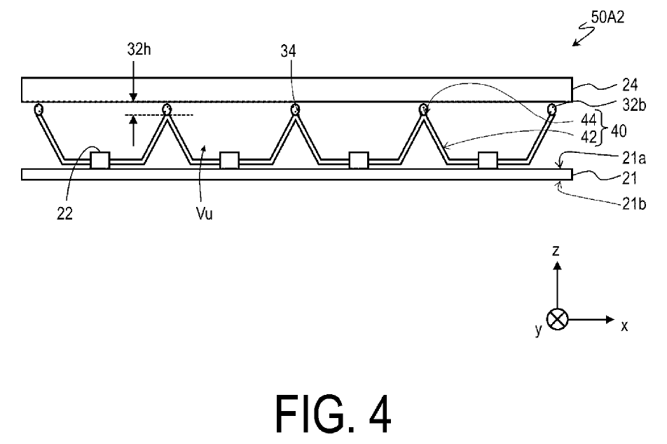

With reference to FIG. 4, a backlight device 50A2 according to a second modification example of the present embodiment will be described. FIG. 4 is a schematic side view illustrating the backlight device 50A2.

The backlight device 50A2 differs from the backlight device 50A in that a plurality of support members 32b include a fluorescent substance 34 that emits fluorescence upon receiving light emitted from the light-emitting elements 22. The fluorescent substance 34 is, for example, a YAG crystal that emits yellow light upon receiving light emitted from the light-emitting elements 22.

Also in the backlight device 50A2, similarly to the backlight device 50A, the luminance contrast ratio between the unit region LU (on) that is turned on and the unit region LU (off) that is not turned on is improved, while luminance unevenness caused by the dividing member 40 is suppressed. In the display device including the backlight device 50A2, similarly to the display device 100A including the backlight device 50A, the display quality is improved.

In the backlight device 50A2, since the support members 32b include the fluorescent substance 34, a local decrease in luminance in a region corresponding to the support members 32b is reduced compared with the backlight device 50A. That is, in the backlight device 50A2, luminance unevenness caused by the support members 32b is reduced compared with luminance unevenness caused by the support members 32 in the backlight device 50A. In the display device including the backlight device 50A2, the display quality can be further improved compared with the display device 100A including the backlight device 50A.

### Third Modification Example

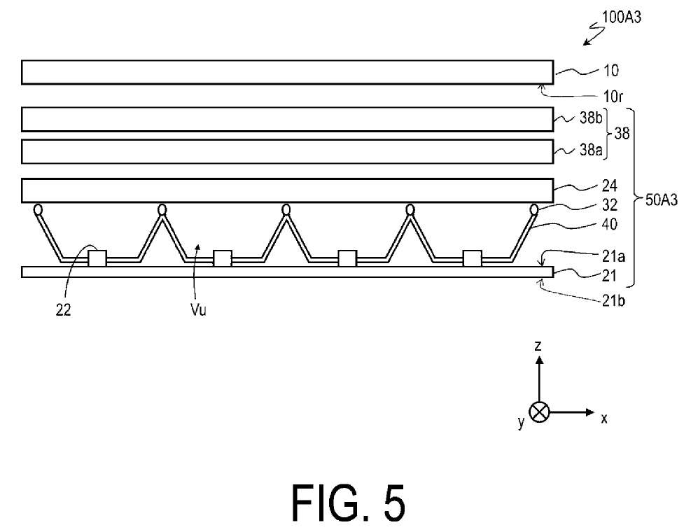

With reference to FIG. 5, a backlight device 50A3 according to a third modification example of the present embodiment and a display device 100A3 including the backlight device 50A3 will be described. FIG. 5 is a schematic side view illustrating the backlight device 50A3 and the display device 100A3 including the backlight device 50A3.

As illustrated in FIG. 5, the backlight device 50A3 differs from the backlight device 50A in that the backlight device 50A3 further includes an optical-layer layered body 38 arranged on a side opposite to the substrate 21 as viewed from the optical sheet 24. Also, in the backlight device 50A3, similarly to the backlight device 50A, luminance unevenness can be suppressed.

The optical-layer layered body 38 may include a plurality of optical sheets. The optical sheet included in the optical-layer layered body 38 may be, for example, a known prism sheet, a microlens sheet, a reflective linear polarizer, or the like. The optical-layer layered body 38 may include two prism sheets arranged such that ridge lines of the respective prisms are substantially orthogonal to each other. As the reflective linear polarizer, for example, a multilayer reflective polarizer (trade name: DBEF, DBEF is a registered trademark) manufactured by 3M Japan Limited may be used. For example, the optical-layer layered body 38 includes a microlens sheet 38a and a reflective linear polarizer 38b arranged on the microlens sheet 38a.

As illustrated in FIG. 5, the display device 100A3 includes the display panel (for example, a liquid crystal display panel) 10 and the backlight device 50A3. In the display device 100A3, the backlight device 50A3 emits light toward the back face 10r of the display panel 10. In the display device 100A3, similarly to the display device 100A including the backlight device 50A, a decrease in the display quality is suppressed.

The first to third modification examples described above are not limited to the first embodiment and may also be applied to the following embodiments.

### Second Embodiment

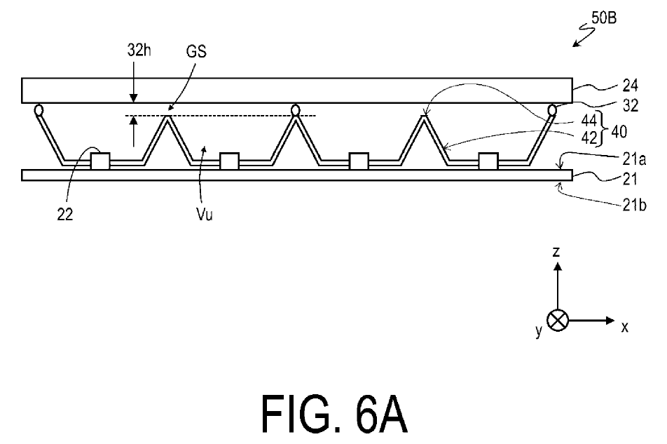

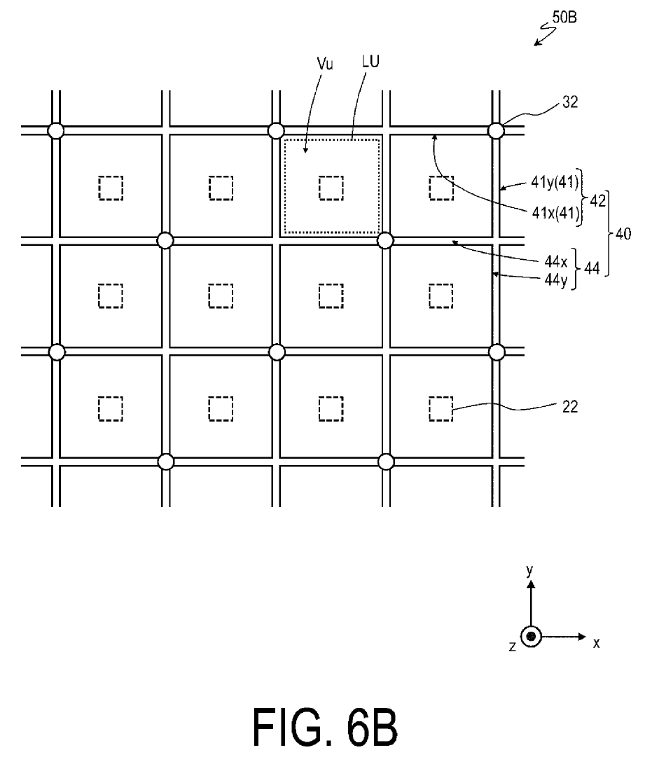

With reference to FIGS. 6A and 6B, a backlight device 50B according to the present embodiment will be described. FIGS. 6A and 6B are, respectively, a side view and a plan view schematically illustrating the backlight device 50B.

The backlight device 50B differs from the backlight device 50A in that a plurality of support members 32 are arranged only in a part of intersections between a plurality of first top portions 44x and a plurality of second top portions 44y in a top view. In the illustrated example, the above-described intersections are two-dimensionally arrayed along a first direction and a second direction, and, in each of the first direction and the second direction, one support member 32 is provided for every two intersections. Further, in this example, the plurality of support members 32 are arranged alternatively. The arrangement of the plurality of support members 32 is not limited to this example, but, in a top view, arranging the plurality of support members 32 more uniformly is preferable from a viewpoint of suppressing luminance unevenness caused by the support members 32.

Also in the backlight device 50B, similarly to the backlight device 50A, a luminance contrast ratio between a unit region LU (on) that is turned on and a unit region LU (off) that is not turned on is improved, while luminance unevenness caused by the dividing member 40 is suppressed. In a display device including the backlight device 50B, similarly to a display device including the backlight device 50A, display quality is improved.

In the backlight device 50B, in a top view, a ratio of a total area of the plurality of support members 32 to an area of a light-emitting face of the backlight device 50B can be made smaller than in a case in which, like the backlight device 50A, the support members 32 are provided at all of the intersections between the plurality of first top portions 44x and the plurality of second top portions 44y. Therefore, in the backlight device 50B, luminance unevenness caused by the support members 32 can be reduced as compared with the backlight device 50A. Further, in the backlight device 50B, manufacturing cost can be reduced as compared with the backlight device 50A.

### Third Embodiment

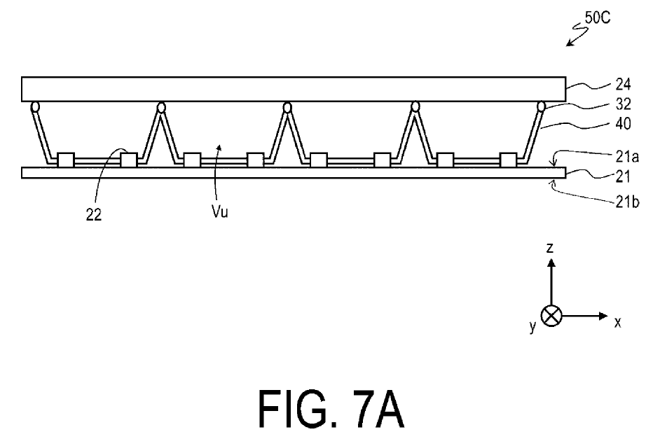

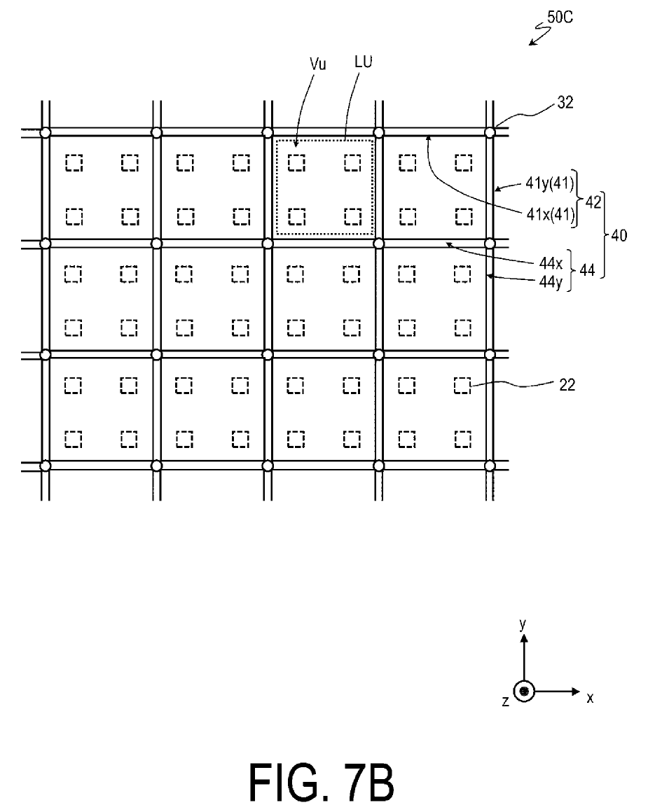

With reference to FIGS. 7A and 7B, a backlight device 50C according to the present embodiment will be described. FIGS. 7A and 7B are, respectively, a side view and a plan view schematically illustrating the backlight device 50C.

The backlight device 50C differs from the backlight device 50A in that a plurality of light-emitting elements 22 (four light-emitting elements 22 in this example) are accommodated in each of a plurality of spaces Vu. The backlight device 50C can perform partial driving with, as a unit, the plurality of light-emitting elements 22 (four light-emitting elements 22 in this example) accommodated in each of the plurality of spaces Vu. A unit region LU of the backlight device 50C includes the plurality of light-emitting elements 22 (four light-emitting elements 22 in this example) accommodated in each of the plurality of spaces Vu. In this example, the number of light-emitting elements 22 accommodated in each of the plurality of spaces Vu arranged in a row direction (first direction) and the number of light-emitting elements 22 accommodated in each of the plurality of spaces Vu arranged in a column direction (second direction) are the same.

Also in the backlight device 50C, similarly to the backlight device 50A, a luminance contrast ratio between a unit region LU (on) that is turned on and a unit region LU (off) that is not turned on is improved, while luminance unevenness caused by the dividing member 40 is suppressed. In a display device including the backlight device 50C, similarly to a display device including the backlight device 50A, display quality is improved.

In the illustrated example, the plurality of support members 32 are arranged, in a top view, at all of the intersections between a plurality of first top portions 44x and a plurality of second top portions 44y, but the plurality of support members 32 may be arranged only at a part of the above-described intersections.

### Fourth Embodiment

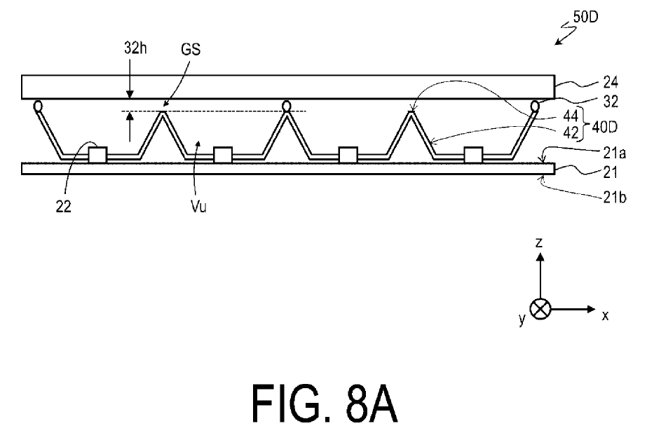

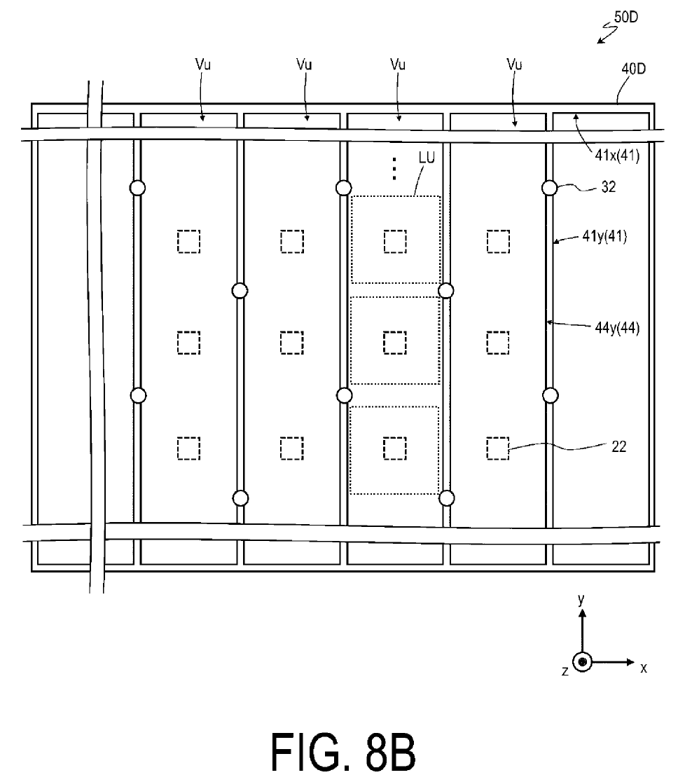

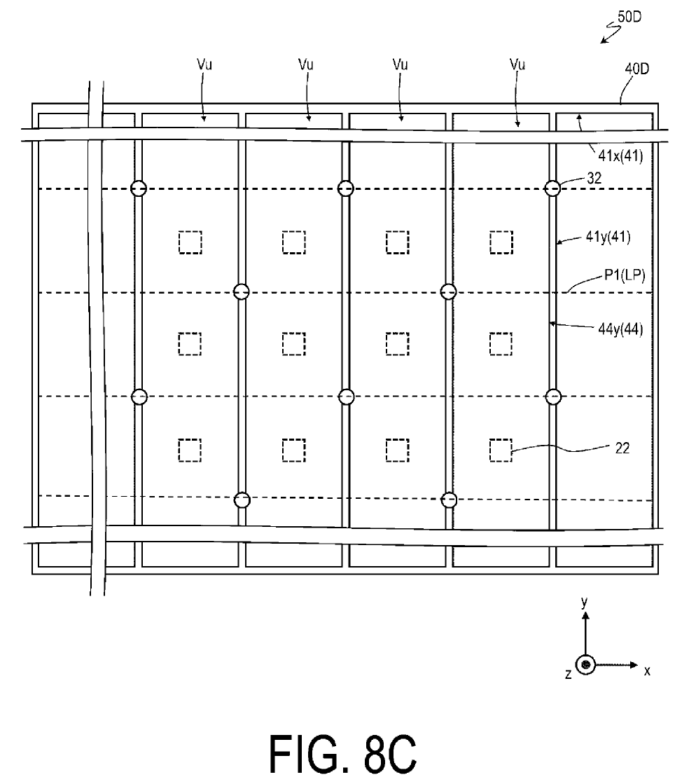

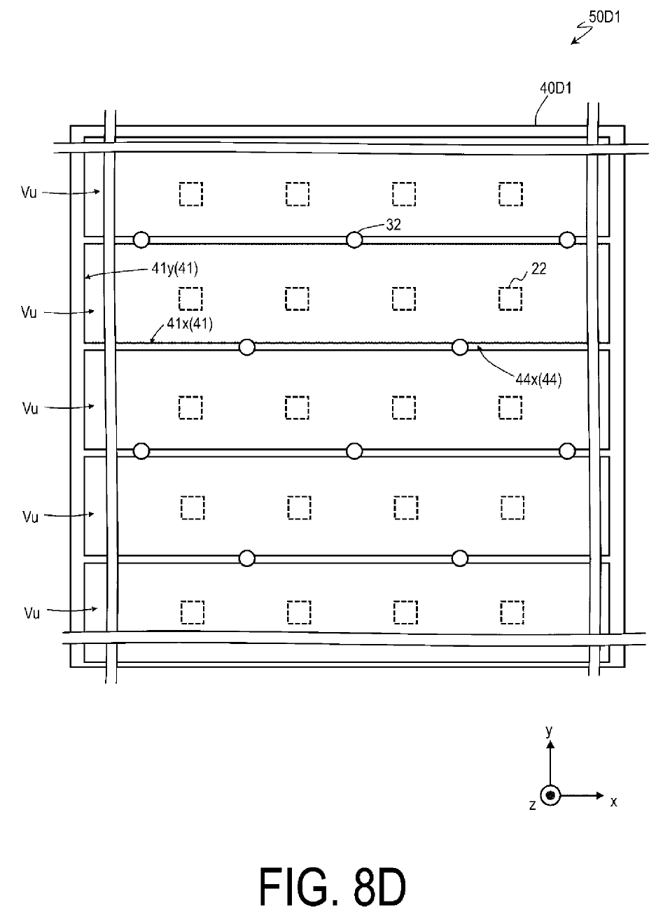

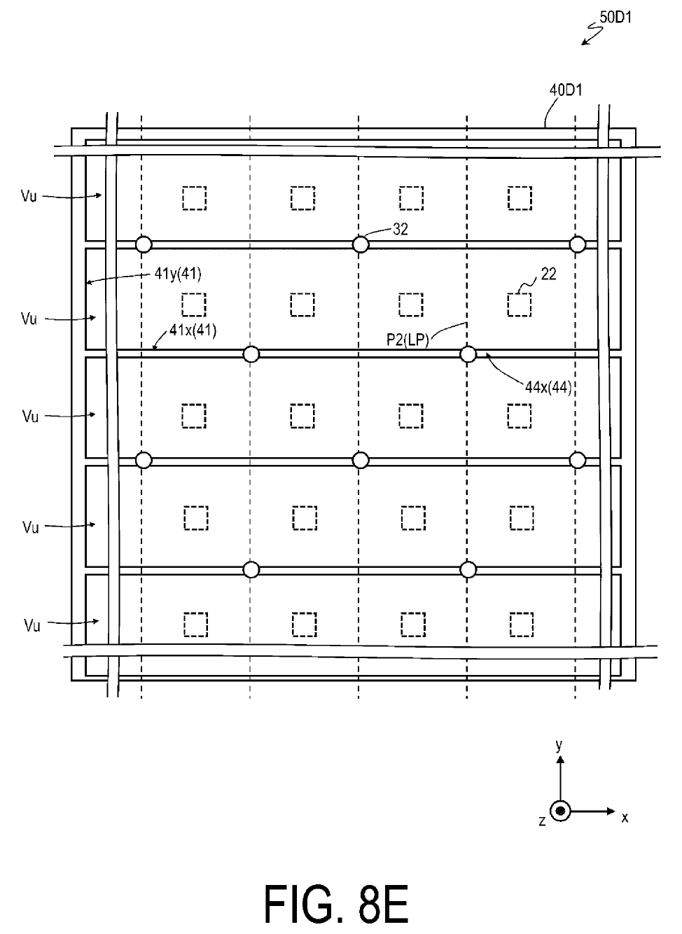

With reference to FIGS. 8A, 8B and 8C, a backlight device 50D according to the present embodiment will be described. FIGS. 8A and 8B are, respectively, a side view and a plan view schematically illustrating the backlight device 50D. FIG. 8C is a schematic diagram for explaining an arrangement of the support members 32 in the backlight device 50D.

In the foregoing embodiment, typically, a unit region LU of the backlight device and a plurality of spaces Vu formed by the dividing member 40 are the same. That is, the backlight device according to the foregoing embodiment can perform partial driving with, as a unit, one or more of the light-emitting elements 22 accommodated in each of the plurality of spaces Vu. In the present embodiment, the unit region LU of the backlight device and a plurality of spaces Vu formed by the dividing member 40 need not coincide with each other.

The backlight device 50D differs from the backlight device 50A in that the backlight device 50D includes a dividing member 40D. The dividing member 40D included in the backlight device 50D is configured such that the plurality of spaces Vu each extending in a second direction are arrayed in a first direction. A top portion 44 of the dividing member 40D includes a plurality of second top portions 44y extending in the second direction and does not include a first top portion extending in the first direction. In each of the plurality of spaces Vu, the plurality of light-emitting elements 22 arrayed in the second direction are accommodated. In the backlight device 50D, as illustrated, each of the plurality of spaces Vu may include the plurality of unit regions LU. In the drawings, for simplicity, only some of the unit regions LU are illustrated.

With reference to FIG. 8C, an arrangement of the support members 32 in the backlight device 50D will be described. FIG. 8C illustrates, together with a plan view of the backlight device 50D illustrated in FIG. 8B, a virtual partition LP having a plurality of first portions (referred to as "a plurality of portions" in some cases) P1 extending in the first direction. In a top view, the plurality of second top portions 44y and the plurality of first portions P1 of the virtual partition LP are formed in a lattice pattern to divide each of the plurality of light-emitting elements 22. In the backlight device 50D, in a top view, the plurality of support members 32 are arranged at intersections between the plurality of second top portions 44y of the top portion 44 of the dividing member 40D and the plurality of first portions P1 of the virtual partition LP. Since the intersections between the plurality of second top portions 44y and the plurality of first portions P1 are farthest from each light-emitting element 22, arranging the plurality of support members 32 at the intersections between the plurality of second top portions 44y and the plurality of first portions P1 can suppress luminance unevenness caused by the plurality of support members 32. The plurality of support members 32 may be arranged, as in the illustrated example, only in a part of the above-described overlapping portions, or may be arranged in all of the above-described overlapping portions.

In the backlight device 50D, since the dividing member 40D does not divide the plurality of light-emitting elements 22 for each unit region, the luminance contrast ratio between the unit region LU (on) that is turned on and the unit region LU (off) that is not turned on is inferior to that of the backlight device 50A. However, in the backlight device 50D, by including the plurality of support members 32, for example, luminance unevenness caused by the dividing member 40 is suppressed as compared with the backlight device 90B according to the second comparative example. Further, manufacturing cost of the backlight device 50D including the dividing member 40D can be reduced as compared with the backlight device 50A including the dividing member 40.

As described above, the top portion 44 of the dividing member 40D included in the backlight device 50D includes the plurality of second top portions 44y extending in the second direction and does not include a first top portion extending in the first direction. In contrast, as in a modified example illustrated in FIGS. 8D and 8E, the top portion 44 of the dividing member 40D may be modified such that the top portion 44 includes the plurality of first top portions extending in the first direction and does not include a second top portion extending in the second direction. Even when modified in this manner, effects similar to those of the backlight device 50D can be obtained.

### Modified Example

With reference to FIGS. 8D and 8E, a backlight device 50D1 according to a modified example of the present embodiment will be described. FIG. 8D is a schematic plan view illustrating the backlight device 50D1, and FIG. 8E is a schematic diagram for explaining an arrangement of the support members 32 in the backlight device 50D1.

As illustrated in FIG. 8D, a dividing member 40D1 included in the backlight device 50D1 differs from the dividing member 40D included in the backlight device 50D in that the plurality of spaces Vu each extending in the first direction are configured to be arrayed in the second direction. That is, the top portion 44 of the dividing member 40D1 included in the backlight device 50D1 includes the plurality of first top portions 44x extending in the first direction and does not include the second top portion extending in the second direction. Also, in the backlight device 50D1, effects similar to those of the backlight device 50D can be obtained.

FIG. 8E illustrates a plan view of the backlight device 50D1 illustrated in FIG. 8D together with the virtual partition LP having the plurality of second portions (referred to as "a plurality of portions" in some cases) P2 extending in the second direction. In a top view, the plurality of first top portions 44x and the plurality of second portions P2 of the virtual partition LP are formed in a lattice pattern to divide each of the plurality of light-emitting elements 22. In the backlight device 50D1, the plurality of support members 32 are arranged, in a top view, at the intersections between the plurality of first top portions 44x of the top portion 44 of the dividing member 40D1 and the plurality of second portions P2 of the virtual partition LP.

The embodiment of the disclosure may be applied to a remote phosphor type backlight device. The remote phosphor type backlight device further includes a phosphor layer provided between the plurality of light-emitting elements 22 and the optical sheet 24 and the phosphor layer emits fluorescence upon receiving excitation light emitted from the plurality of light-emitting elements 22. Also in the remote phosphor type backlight device, similarly to the above-described examples, luminance unevenness caused by the dividing member can be suppressed.

### INDUSTRIAL APPLICABILITY

According to the backlight device according to the embodiment of the disclosure, luminance unevenness caused by the dividing member can be suppressed. By using the backlight device according to the embodiment of the disclosure, a decrease in display quality of a display device can be suppressed.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A backlight device, comprising:
a substrate having a main surface;
an optical sheet facing the main surface of the substrate;
a plurality of light-emitting elements supported on the main surface of the substrate and configured to emit light toward the optical sheet;
a dividing member forming, between the main surface of the substrate and the optical sheet, a plurality of spaces each accommodating one or more of the plurality of light-emitting elements, the dividing member including a plurality of wall portions each surrounding, in a top view, the light-emitting elements accommodated in each of the plurality of spaces, and a plurality of top portions each connecting the wall portions adjacent to each other in the plurality of wall portions; and
a plurality of support members each in contact with the top portions of the dividing member and configured to support the optical sheet.

2. The backlight device according to claim 1,
wherein a gap is formed between the optical sheet and portions of the top portions of the dividing member not in contact with the support members.

3. The backlight device according to claim 1,
wherein the plurality of support members are separated from each other in a top view.

4. The backlight device according to claim 1,
wherein the plurality of top portions include a plurality of first top portions extending in a first direction in a top view, and a plurality of second top portions extending in a second direction intersecting the first direction in a top view.

5. The backlight device according to claim 4,
wherein each of the plurality of support members is provided at some or all intersections between the plurality of first top portions and the plurality of second top portions.

6. The backlight device according to claim 4,
wherein the plurality of top portions are formed in a lattice pattern including the plurality of first top portions and the plurality of second top portions in a top view.

7. The backlight device according to claim 4,
wherein each of the plurality of support members is not provided anywhere other than at intersections between the plurality of first top portions and the plurality of second top portions.

8. The backlight device according to claim 1,
wherein the plurality of top portions include either a plurality of first top portions extending in a first direction in a top view, or a plurality of second top portions extending in a second direction intersecting the first direction in a top view.

9. The backlight device according to claim 8,
wherein the plurality of top portions include the plurality of first top portions, when assuming a virtual partition including a plurality of portions extending in the second direction, the plurality of first top portions and the plurality of portions being formed in a lattice pattern in a top view, and dividing each of the plurality of light-emitting elements, the plurality of support members are arranged, in a top view, at intersections between the plurality of first top portions and the plurality of portions.

10. The backlight device according to claim 8,
wherein the plurality of top portions include the plurality of second top portions, when assuming a virtual partition including a plurality of portions extending in the first direction, the plurality of second top portions and the plurality of portions being formed in a lattice pattern in a top view, and dividing each of the plurality of light-emitting elements, the plurality of support members are arranged, in a top view, at intersections between the plurality of second top portions and the plurality of portions.

11. The backlight device according to claim 1,
wherein the plurality of support members have light reflectivity.

12. The backlight device according to claim 1,
wherein the plurality of support members include a fluorescent substance emitting fluorescence upon receiving the light.

13. A display device, comprising:
a display panel; and
a backlight device according to claim 1, the backlight device configured to emit light toward a back face of the display panel.
